(19) United States
(12) Patent Application Publication
(10) Pub. No.: US 2026/0303958 A1
(43) Pub. Date: Oct. 1, 2026

(54) DETECTING AND PROMPTING DISTRACTED PHOTOGRAPH SUBJECTS VIA ELECTRONIC DEVICE DURING IMAGE CAPTURE

(71) Applicant: MOTOROLA MOBILITY LLC, WILMINGTON, DE (US)

(72) Inventors: RANJEET GUPTA, AURORA, IL (US); RAHUL BHARAT DESAI, HOFFMAN ESTATES, IL (US)

(21) Appl. No.: 19/094,950

(22) Filed: Mar. 30, 2025

(51) Int. Cl. H04N 23/60; G06F 3/16; G06V 40/16; H04N 23/611

(52) U.S. Cl. CPC H04N 23/64; G06F 3/16; G06V 40/168; H04N 23/611

(57) ABSTRACT

A method of prompting unresponsive photograph subjects to direct their gaze toward an electronic device operative to capture their images. The method includes capturing at least one preview image of one more photograph subjects in a field of view (FOV) of a first camera of the electronic device. The method includes analyzing the at least one preview image to determine whether a gaze of at least one photograph subject among the one or more photograph subjects is not directed toward the electronic device. The method includes, in response to detecting that the gaze of at least one photograph subject is not directed toward the electronic device, identifying characteristics of the at least one photograph subject, and generating and output, via the at least one audio output device, a first audible audio message to prompt the at least one photograph subject to look towards the electronic device.

### BACKGROUND

### 1. Technical Field

The present disclosure generally relates to electronic devices, and more specifically to electronic devices configured to capture photographic images.

### 2. Description of the Related Art

Myriad handheld electrical devices are now capable of taking photographs. These devices can have various form factors and have one or more visible integrated displays. Devices such as foldable smartphones having rear-facing and forward-facing display screens allow photographers to preview the image to be taken and can also offer a visual prompt to the photograph subjects. While clamshell or flip form factor devices are especially useful for such tasks, electronic devices having a candy bar form factor can work equally well to provide this feature.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to implement visual and audio prompting of distracted photograph subjects, according to one or more embodiments;

FIG. 1B is an additional block diagram representation of the electronic device of FIG. 1A presenting additional components, including components for wireless communications with other devices within a connected device ecosystem, according to one or more embodiments;

FIG. 1C depicts a front flat view of an example electronic device, presented as a flip phone having a top housing and a bottom housing that are connected via a centrally located hinge, according to one or more embodiments;

FIG. 1D depicts a back flat view of the example electronic device of FIG. 1C, according to one or more embodiments;

FIGS. 2A-2B depict a sequence by which the electronic device assesses and interacts with photograph subjects to provide visual and audio prompting of distracted photograph subjects, according to a plurality of embodiments;

FIGS. 3A-3B depict the analysis of photograph subjects by the electronic device and the view visible to the user on a graphical user interface during visual and audio prompting of distracted photograph subjects, according to a plurality of embodiments;

FIGS. 4A-4B (collectively FIG. 4) depict a flowchart presenting a method of evaluating attentiveness of photographic subjects and outputting visual and audio prompting for distracted photograph subjects, according to one or more embodiments.

### DETAILED DESCRIPTION

According to aspects of the present disclosure, an electronic device, a method, and a computer program product provide automated assessment of a readiness of photograph subjects to take a photographic image and audio and visual prompting of the photographic subjects to look towards the image capturing device. More specifically, a handheld electronic device can scan photograph subjects in the field of view of a sensor or camera, analyze the facial expressions of photographs subjects to determine whether they are gazing at the electronic device, and capture an image or provide further prompting to adjust a gaze towards the electronic device, based on the results of the analysis.

Distracted photograph subjects typically lead to a non-ideal resulting photograph, with the subjects not looking towards the cameras. The photographer may be unaware during image capture, particularly in situations where there are multiple subjects, and the image is captured while one or more of the subjects are not looking towards the camera. When the photographer is aware, he/she is forced to verbally prompt or gesture at a subject who is looking away from the camera, and may have to repeat this process for multiple subjects, which can be frustrating to the photographer. Some conventional electronic devices, such as smartphones, commonly used to take pictures eliminate the need for such user actions by, for example, playing a cartoon on a display that faces the photograph subjects to draw the attention of the photograph subjects towards the electronic device. Such methods can be effective, if the heads of subjects are not turned away from the electronic device. However, such methods fail to inform subjects of their current position relative to ideal positioning for the photograph. The present disclosure overcomes the limitations in these conventional systems by providing a mechanism/process that allows the subjects to preview their current expressions and also prompts the specific subject that is looking away to modify his/her gaze before a photograph is taken. In accordance with some aspects of the present disclosure, the inconvenience of having to verbally prompt or manually gesture to a distracted photograph subject and the risk of failing to attract the attention of a distracted photograph subject with animation on a screen of a handheld electronic device that a photograph subject may not be looking towards are mitigated. Elements of the present innovation, including presenting a visual preview visible to photograph subjects and simultaneous verbal prompts incorporating identifying descriptions of distracted photograph subjects eliminate the need for the user to visually identify when any one of a plurality of subjects is not gazing towards the device, manually prompt a distracted photograph subject, or rely on only semi-reliable methods of automatically prompting all of the photograph subjects.

According to one embodiment, the electronic device includes at least one audio output device. The electronic device includes at least one image capturing device comprising a first camera embedded in the outward facing surface of the housing of the electronic device. The electronic device includes at least a memory having stored thereon a photograph gaze correction prompt (GCP) module for prompting photograph subjects who are not looking towards the electronic device to look towards the electronic device. The electronic device includes at least one processor communicatively coupled to the at least one audio output device, the at least one camera, and the memory. The at least one processor executes program code of the photograph gaze correction prompt module, and is configured to cause the electronic device to, while the electronic device is in an image capture mode, use the first camera to capture at least one preview image in a first field of view (FOV) of the first camera of one or more photograph subjects. The at least one processor is configured to cause the electronic device to analyze the at least one preview image to determine whether a gaze of at least one photograph subject among the one or more photograph subjects is not directed toward the electronic device, and, in response to detecting that the gaze of at least one photograph subject is not directed toward the electronic device: identify characteristics of the at least one photograph subject; and generate and output, via the at least one audio output device, a first audible audio message to prompt the at least one photograph subject to look towards the electronic device.

According to one aspect of the disclosure, a method is disclosed for implementing visual and audio prompting of distracted photograph subjects. The method includes capturing at least one preview image of one or more photograph subjects in a field of view (FOV) of a first camera of an electronic device. The method includes analyzing the at least one preview image to determine whether a gaze of at least one photograph subject among the one or more photograph subjects is not directed toward the electronic device. The method includes, in response to detecting that the gaze of at least one photograph subject is not directed toward the electronic device: identifying characteristics of the at least one photograph subject; and generating and outputting, via the at least one audio output device, a first audible audio message to prompt the at least one photograph subject to look towards the electronic device.

Also disclosed is a computer program product comprising a non-transitory computer readable medium having computer program product instructions, that when executed by a processor of an electronic device, configures the electronic device to perform the above-presented and other method functions.

The above description contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with ordinary skill in the art upon examination of the figures and the remaining detailed written description. The above as well as additional objectives, features, and advantages of the present innovation will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program products include a non-transitory computer readable storage device having program instructions or code stored thereon, the code configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those of ordinary skill in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present innovation is defined by at least the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present innovation. Instances of such phrases in various places within the specification do not necessarily all refer to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. does not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest reasonable interpretation given the context in which that term is utilized.

Those of ordinary skill in the art will appreciate that the hardware components and basic configuration depicted in the following figures may vary. The illustrative components are not intended to be exhaustive, but rather are representative to highlight essential components that can be utilized to implement aspects of the described embodiments. For example, other devices/components may be used in addition to, or in place of, the hardware and/or firmware depicted. The depicted examples are not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, or otherwise) on the described embodiments.

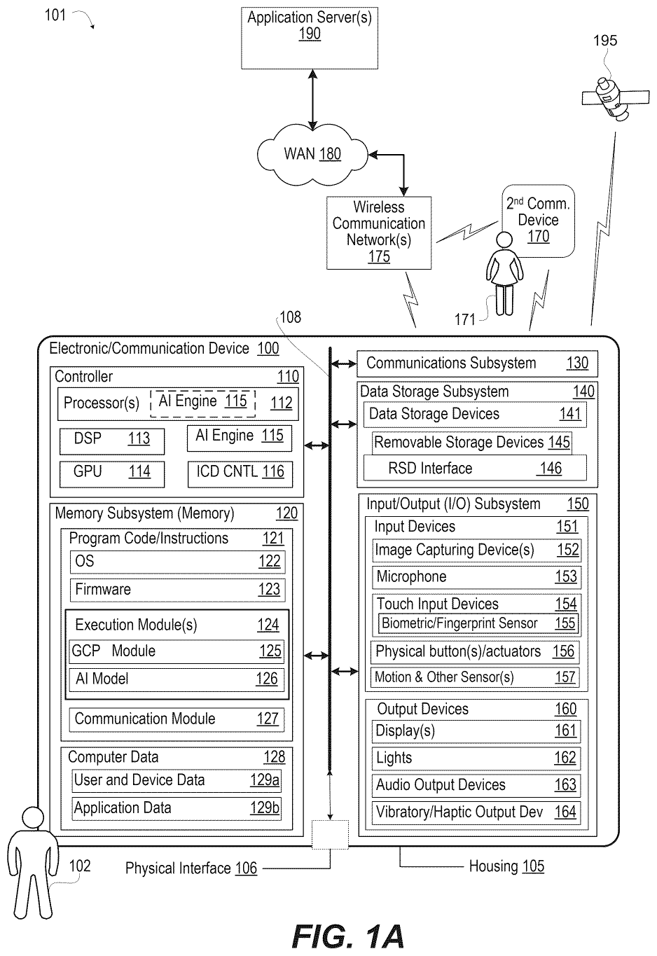

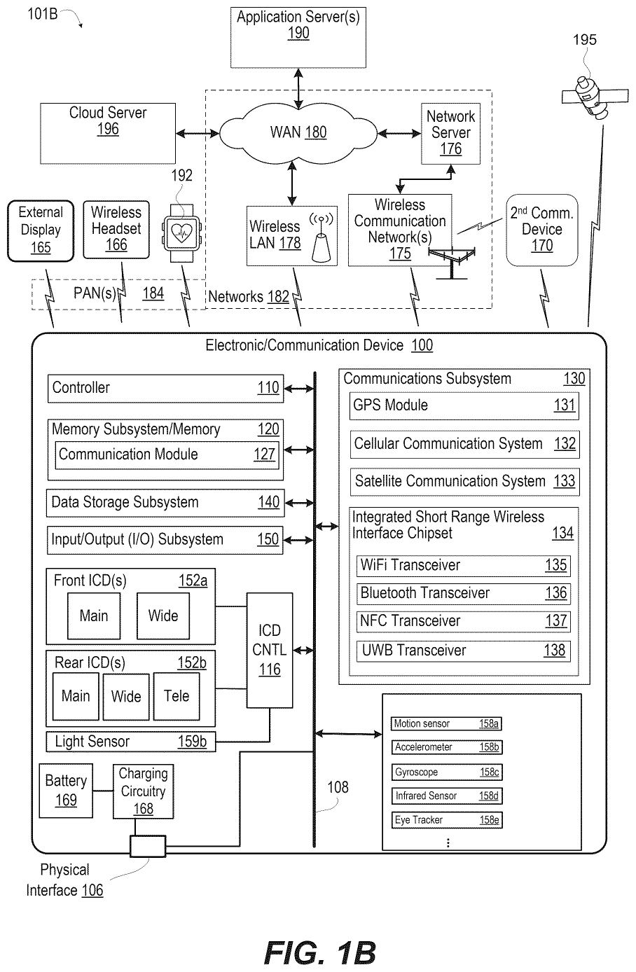

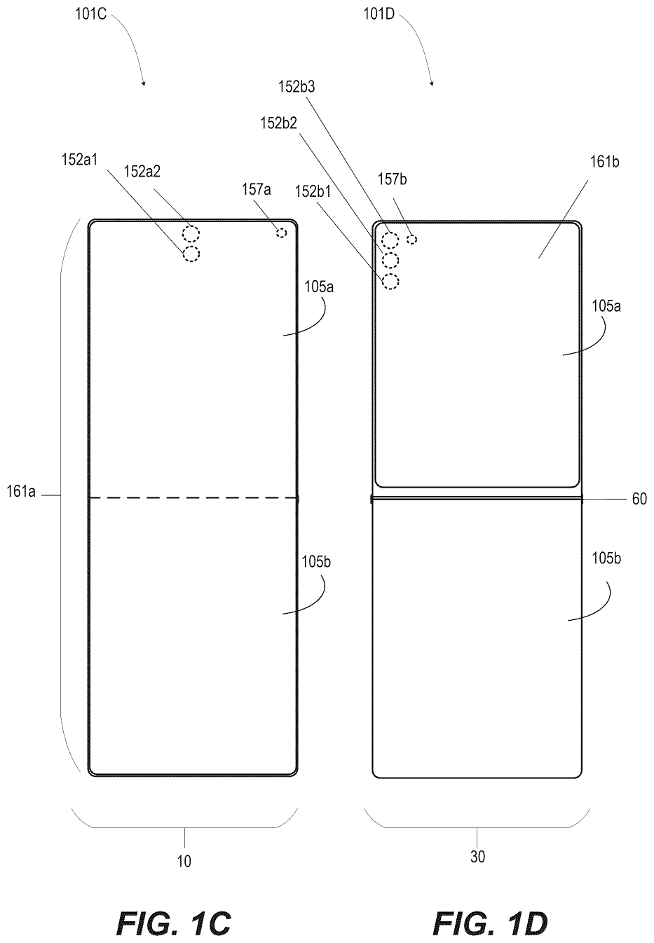

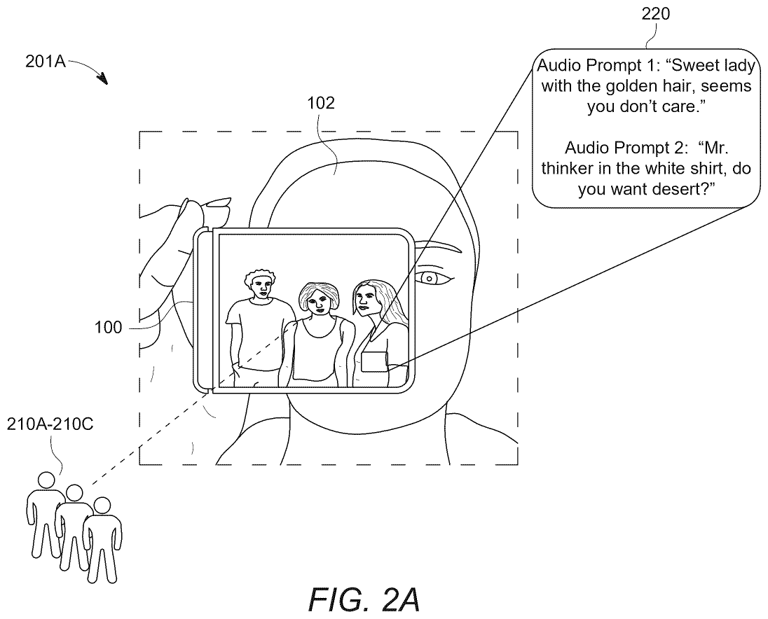

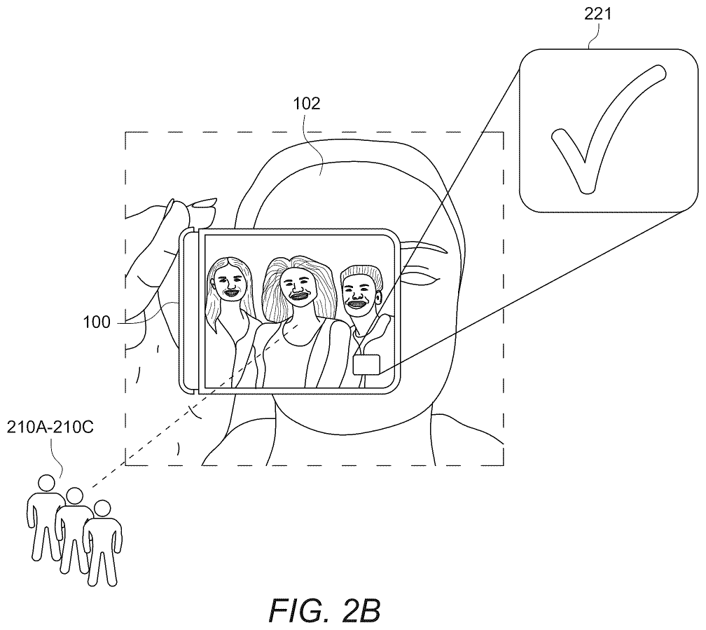

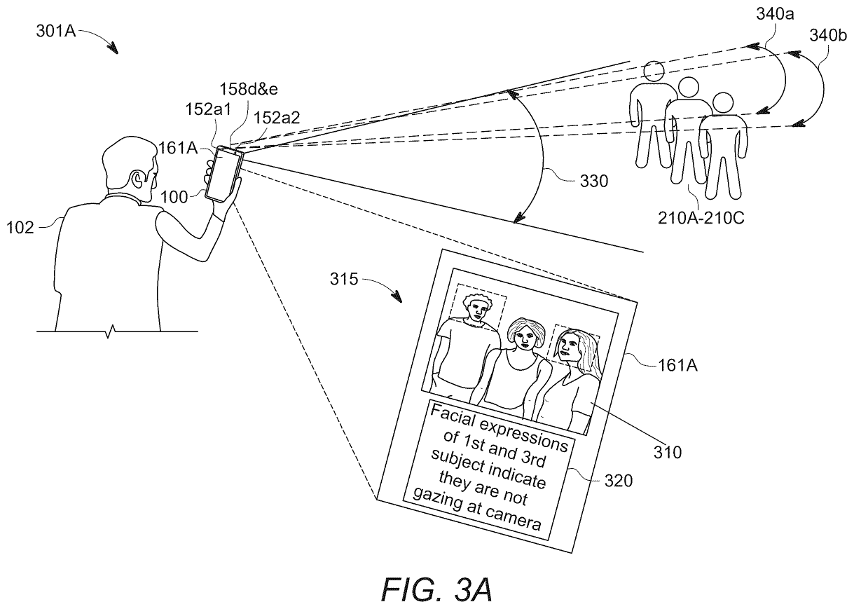

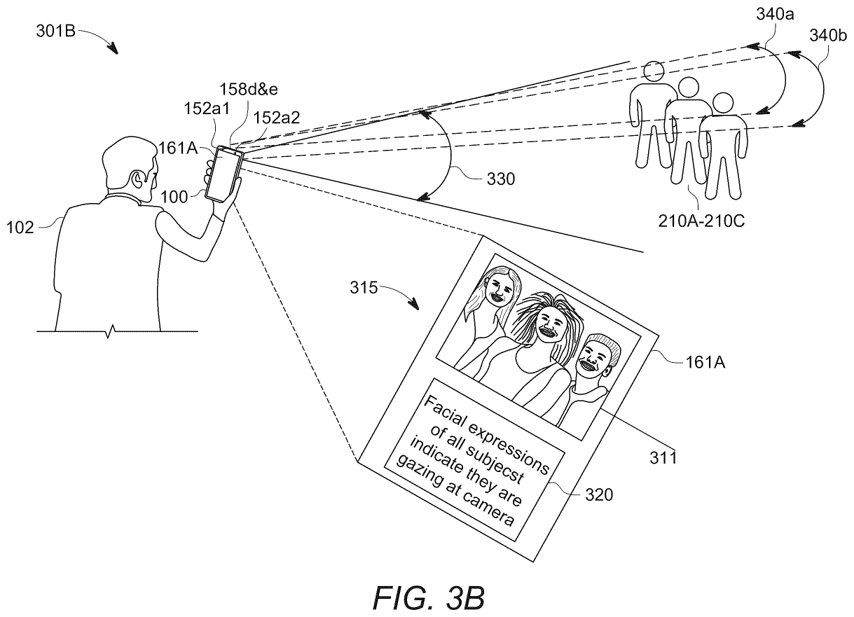

Referring now to the figures and beginning with FIG. 1A, there is illustrated a block diagram of an example electronic device 100 in a communication environment 101 and having hardware and software components, which enable the features of the present disclosure to implement visual and audio prompting of distracted photograph subjects, according to one or more embodiments. Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of the description of the various embodiments herein, FIG. 1 (FIG. 1A and FIG. 1B) is presented as/from the perspective of electronic device 100, which is the device operative to implement functionality in accordance with an assessment regarding whether the photograph subjects require prompting. FIGS. 1C and 1D present an embodiment of electronic device configured with a clam shell or flip phone form factor presenting multiple cameras and display screens. FIGS. 2A-2B, and 3A-3B, show the assessment process from the perspective of the photograph subjects and the user 102 of the electronic device 100, respectively.

Referring to FIG. 1A, electronic device 100 generally includes controller 110, memory (or memory subsystem) 120, communications subsystem 130, data storage subsystem 140, and input/output subsystem 150, all contained within or extended from an exterior surface of device housing 105. As shown by FIGS. 1C-1D and 2A-2B, described hereafter, device housing 105 can include two separate housing portions that are connected via a joint or hinge section to allow for rotation of one portion of the housing relative to the other. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113 graphics processing units (GPUs) 114, artificial intelligence (AI) engines 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of communication device 100. These functions and/or operations include, but are not limited to application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores program code/instructions 121 for execution by processor 112 to configure processor 112 (and more generally electronic device 100) to provide the operational functions and features described herein. Program code/instructions 121 (or program code 121 for short) includes instructions for an operating system (OS) 122, and firmware 123, such as basic input/output system (BIOS) or Uniform Extensible Firmware Interface (UEFI). Program code 121 includes execution module(s) 124 that collectively provide the various features of the disclosure. Execution module(s) 124 include, without limitation, photograph gaze correction prompt (GCP) module 125, which provides the features and operating functionality of the disclosed embodiments when the corresponding program instructions of GCP module 125 are processed by/within processor 112/controller 110. Specifically, GCP module 125 provides program instructions for determining whether photograph subjects are engaged in the photograph process, generating auditory and visual stimulus to prompt photograph subjects to engage, and capturing a persistent image of all photograph subjects when they are engaged.

Execution module(s) 124 further include AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within GCP module 125 and is trained to support the AI features of GCP module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, GCP module 125 can include program instructions that cause or configure controller 110 or processor 112 to cause electronic device 100 to, while the electronic device 100 is in an image capture mode, using the first camera 152 capture at least one preview image captured in a first field of view (FOV) of the first camera 152 of one or more photograph subjects. The controller 110 is further configured to cause the electronic device 100 to analyze the at least one preview image to determine whether a gaze of at least one photograph subject among the one or more photograph subjects is not directed toward the electronic device 100. The controller 110 is further configured to cause the electronic device 100 to, in response to detecting that the gaze of at least one photograph subject is not directed toward the electronic device 100: identify characteristics of the at least one photograph subject; and generate and output, via the at least one audio output device, a first audible audio message to prompt the at least one photograph subject to look towards the electronic device 100.

In a further embodiment, controller 110, is further configured to cause the electronic device 100 to determine, after outputting the first audible audio message to prompt the at least one photograph subject to look towards the electronic device 100, whether each photograph subject in the field of view of the first camera is looking towards the electronic device. The controller 110, is further configured to cause the electronic device 100 to, in response to detecting that each photograph subject of the one or more photograph subjects is looking towards the electronic device 100, activate the first camera 152 to capture a persistent image of a scene within the first field of view (FOV) of the first camera 152.

In another embodiment, the characteristics of the at least one photograph subject comprise one or more of eye color, hair color, ethnicity, height, build, and style of clothing. In order to generate the audible audio message, the at least one processor is configured to cause the electronic device to interface with a first AI model 126, the first AI model 126 being trained beforehand on identified characteristics of several previous photograph subjects captured in several prior persistent images and operative to ingest in real time identified characteristics of the at least one photograph subject and output an audible audio message tailored to the at least one photograph subject.

In a further embodiment, controller 110/processor 112, is further configured to cause the electronic device 100 to, in response to determining that one or more photograph subjects are still not looking at the electronic device 100, repeat a presentation of subject-tailored audible audio messages a preset number of times (e.g., twice). The controller 110, is further configured to cause the electronic device 100, in response to determining that one or more photograph subjects are still not looking at the electronic device 100 after presenting a preset number of repeated audible prompts, trigger activation of the capturing of the image.

In another embodiment, controller 110 is further configured to cause the electronic device 100 to map a face of each photograph subject among the one or more photograph subjects. The controller 110 is further configured to cause the electronic device 100 to interface with a second AI model 126 trained beforehand on images of persons looking towards a camera and images of persons looking away from a camera 152. The controller 110 is further configured to cause the electronic device 100 to, in order to determine whether the at least one photograph subject is not looking toward the electronic device 100: process the first preview image through an artificial intelligence engine 115 to identify a first facial characteristic of the at least one photograph subject and compare the first facial characteristic with the images on which the AI model 126 was trained.

In another embodiment, the electronic device 100 further comprises a foldable enclosure comprising a first housing 105a and a second housing 105b coupled by a hinge, such that the first housing is pivotable about the hinge relative to the second housing between a closed position and an axially displaced open position (e.g., approximately 90 degrees). The electronic device 100 further comprises a first display 161b embedded in an outward facing surface of a housing 105 of the electronic device, a second display 161a embedded in an inward facing surface of the housing 105 of the electronic device opposed to the outward facing surface of the housing 105 in which the first display 161b and first camera 152 are embedded. The second display is communicatively coupled to the at least one processor 112. The at least one processor 112 is configured to cause the electronic device to: present a first graphical user interface (GUI) on the second display 161a, the first GUI including the first preview image captured via the first camera 152 and an indicator identifying whether or not all photograph subjects in the FOV of the first camera 152 are looking at the electronic device 100.

In a further embodiment, the controller 110, is further configured to cause the electronic device 100 to present the first preview image on the first display 161b concurrently with the presentation of the first preview image on the second display 161a.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at communication device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 170 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141 Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of communication device 100 can include removable storage device(s) (RSD(s)) 145, which are received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of GCP module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user 102. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in FIG. 1B description.

With reference to FIG. 1B, as illustrated, motion and other sensor(s) 157 of electronic device 100 include, but are not limited to, one or more motion sensor(s) 158a, one or more accelerometers 158b, one or more altimeters, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Other sensor(s) 157 may also include one or more infrared (IR) facial sensors 158d or eye trackers 158e. IR facial sensor 158d may use near-infrared (NIR) light to generate a 3D map of the face of a photograph subject, allowing for secure and reliable facial recognition, even in low-light conditions. Eye trackers 158e may be a combination of an NIR sensor and a high-resolution camera operative to detect any change in the position of the eyes of a photograph subject in its field of vision (FOV).

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface 154 can be utilized as an input device. The touch screen interface 154 can include one or more virtual buttons or selectable affordances. In one or more embodiments, when a user applies a finger or stylus on the touch screen interface 154 in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of housing 105. Other embodiments provide for multiple integrated displays within electronic device 100 and references to display(s) 161 are assumed to refer to one or all of these multiple integrated displays. Yet other embodiments can include external displays 161 that are not integrated into the main body of electronic device 100 but are wired or wirelessly connected to the other components of electronic device 100 to provide the input/output features similar to integrated display 161.

Vibration device 164 can cause electronic device 100 to vibrate or shake when activated. Vibration device 164 can be activated during an incoming call or message in order to provide an alert or notification to a user 102 of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101B. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101B that includes other devices.

Communications subsystem 130 includes a global positioning system (GPS) module 131 that enables electronic devices to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem 130 includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to utilize long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a WiFi router of a wireless local area network (WLAN) 178 and/or second electronic device 170, via one or more short-range wireless interface(s). Second electronic device 170 can be a communication device, such as a smartphone, and/or can be similarly configured as electronic device 100. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of GCP module 125 and/or access to other applications, online transactions, and resources. In one or more embodiments, the WAN 180 can enable electronic device 100 to access a cloud server 196, which can receive and store data from electronic device 100 to be downloaded and used by second electronic device 170. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as a data port and can be used as a power supply port that is coupled to charging circuitry 168 which feeds electrical power to device battery 169 to enable recharging of device battery 143 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image or iris scan recognition.

In the description of each of the following figures, reference is also made to specific components illustrated within the preceding figure(s). Similar or same components are presented with the same leading reference number.

FIGS. 1C and 1D illustrate front and back flat views, respectively, of an example foldable electronic device 100, which is one implementation of electronic device 100. Foldable electronic device 100 is presented as a flip phone having a top housing 105a and a bottom housing 105b that are connected via a centrally located hinge 60, according to one or more embodiments. FIG. 1C shows an example front display (or front facing display) 161a that extends across the entire front surface 10 of housing 105 of electronic device 100. FIG. 1D shows the hinge 60 connecting the top and bottom housing 105a and 105b. Top housing 105a also includes rear display (or rear facing display) 161b integrated into rear surface 30 of top housing 105a. Embedded within front surface 10 of the top housing 105a are two front-facing cameras, main front facing camera 152a1 and front facing wide-angle camera or panoramic camera 152a2. Embedded within the rear surface of the top housing are three rear-facing cameras, rear facing telephoto camera 152b1, main rear facing camera 152b2, and rear facing wide-angle camera or panoramic camera 152b3. Top housing 105a may also include at least one front facing motion sensor or other sensor 157a and at least one rear facing motion sensor or other sensor 157b. The numbers and locations of the cameras 152a1, 152a2, 152b1, 152b2, and 152b3 may vary with the description above in so far as there may be more or fewer front or rear cameras than described above and the front or rear cameras may be located at portions of the periphery of the front surface 10 that differ those described above or depicted in FIG. 1C and FIG. 1D or take the form of a camera under display (CUD).

Within the described embodiments, as part of the process of implementing visual and audio prompting of distracted photograph subjects, the front facing display (second display) 161a presents, in view of the user 102, a first graphical user interface (GUI) which renders a first preview image captured via the first camera 152b and also renders an indicator identifying whether or not all photograph subjects in the FOV of the first camera 152b are looking at the electronic device 100. Simultaneously, the preview image is rendered on the rear facing display (first display) 161b in view of the photograph subjects. While foldable form factor described above is well suited to carry out the functionality described herein, a candy bar form factor or other form factors may be equally suitable.

In the description of each of the following figures, reference is also made to specific components illustrated within the preceding figure(s). Similar or same components are presented with the same leading reference number.

FIGS. 2A-2B depict the process of by which electronic device 100 presents visual and audio prompting to distracted photograph subjects, from the perspective of photograph subjects 210a-210c. According to one or more embodiments, a photograph subject is identified by the electronic device as being distracted if the subject is determined to be looking away from the electronic device. Conversely, a photograph subject looking in the general direction of the electronic device 100 is identified as being engaged in the photo capture process and ready for photo capture. From a practical implementation standpoint, and in accordance with the described embodiments, engagement of a subject is measured in terms of whether the photograph subject is looking at/towards the electronic device, as opposed to looking directly at the camera 152 within said device, because the FOV of the camera 152 is wide enough to allow, in a captured image, photograph subjects 210a-210c to appear to be looking at the camera, as long as the person is looking towards the direction of the electronic device 100.

FIGS. 2A-2B depict a sequence by which the electronic device assesses and interacts with photograph subjects during visual and audio prompting of distracted photograph subjects, according to a plurality of embodiments. FIG. 2A illustrates the sequence of events that occurs when photograph subjects 210a-210c are assessed and found to be distracted during an attempt to photograph them. While in an image capture mode, the electronic device 100 uses the first camera 152 on the rear facing surface 30 of the electronic device 100 to capture at least one preview image captured within the first field of view (FOV) of first camera 152 of the one or more photograph subjects 210a-210c. The electronic device 100 analyzes the preview image to determine whether a gaze of at least one photograph subject 210a-210c among the one or more photograph subjects 210a-210c is not directed toward the electronic device 100. In the example of FIG. 2A, the electronic device 100 determines that the gazes of two of the photograph subjects 210a-210c (i.e., the first and third photograph subjects) are not directed toward the electronic device 100. Then, the electronic device 100 identifies characteristics of the distracted photograph subjects, such as eye color, hair color, ethnicity, height, build, style of clothing, distinguishable markings, such as a tattoo, etc. A first display 161b embedded in an outward facing surface of the housing 105 of the electronic device presents, to the photograph subjects 210a-210c, the first preview image as the photographic subjects are in line-of-sight with the first display 161b. Simultaneously, processor 112 of the electronic device 100 generates and outputs, via an audio output device 163 (e.g., externally presenting speaker), an audible audio message 220 prompting each specifically identified distracted photograph subject to look towards the electronic device 100. The audible audio messages 220 include some aspects of the identified characteristics of the distracted photograph subjects 210a-210c. In one or more embodiment, to generate the audible audio messages 220, the controller 110 causes the electronic device 100 to interface with a first AI model 126a, the first AI model 126a being trained beforehand on identified characteristics of several previous photograph subjects captured in several prior persistent images and operative to ingest in real time identified characteristics of the at least one current, distracted photograph subject and output an audible audio message tailored to the at least one current distracted photograph subject 210a-210c. As illustrated, the audio prompt to the first distracted users is, “Sweet lady with the golden hair, seems you don't care.” The audio prompt to the second distracted users is, “Mr. thinker in the white shirt, do you want desert?” By describing the photograph subjects 210a-210c using a rhyme or other catchy audible output with a link/reference to the subject's identified characteristics, the generated notifications grab the attention of the particular distracted photograph subjects 210a-210c, causing those subjects to look towards the electronic device 100.

FIG. 2B illustrates the results of the prompting shown in FIG. 2A. Here, all photograph subjects 210a-210c within the FOV 330 of the first camera 152 are looking in the general direction of the electronic device, as is evident from the preview image shown on the first display 161b. No audio queue is offered for photograph subjects 210a-210c being engaged. However, a check mark or other symbol of affirmation 221 may be rendered on the first display 161b along with the preview image.

FIGS. 3A-3B depict the analysis of photograph subjects willingness to gaze towards the electronic device 100 to facilitate image capture by the electronic device and a graphical user interface presented on the second display, viewable to the user during visual and audio prompting of distracted photograph subjects, according to a plurality of embodiments. While a preview image 310 is being rendered on first (rear) display 161b as described in relation to FIG. 3A, the same preview image 310 is simultaneously rendered on a second (front) display 161a. The second display 161a, which faces the user, is embedded in an inward facing surface 30 of the housing 105 of the electronic device 100, which is opposed to the outward facing surface 10 of the housing 105 in which the first display 161b and first camera 152 are embedded. The second display 161a is communicatively coupled to the at least one processor 112. The at least one processor 112 is configured to cause the electronic device to: present a first graphical user interface (GUI) 315 on the second display 161a, the first GUI 315 including the first preview image captured via the first camera 152 and an indicator 320 identifying whether or not all photograph subjects 210a-210c in the FOV 330 of the first camera 152 are looking at the electronic device 100.

As described in relation to FIGS. 2A and 2B, in FIG. 3A, analysis of the willingness of photograph subjects to gaze at the electronic device of their own volition and their reaction to necessary visual and audio prompting, can include an assessment of the preview image 311 captured in the FOV 330 of the first camera 152. However, in the presented embodiment, electronic device 100 includes an IR sensor 158d and/or eye tracker sensor 158e, which are physical components versus software modules, in other embodiments. With this configuration of electronic device 100, identifying a level of the engagement of the photograph subjects 210a-210c can also be based on information gathered within the FOV 340a and FOV 340b of the IR sensor 158d and/or the eye tracker sensor 158e, respectively. This process involves the controller 110 configuring the electronic device to cause the IR sensor 158d to map the face of each photograph subject 210a-210c among the one or more photograph subjects 210a-210c. Additionally, the controller 110 configures the electronic device 100 to interface with a second AI model 126b trained beforehand on images of persons looking towards a camera and images of persons looking away from a camera, prior to the image capturing session. Controller 110 configures the electronic device 100 to determine whether one or more one photograph subjects 210a-210c is/are not looking toward the electronic device 100. The analysis process concludes with the controller 110 configuring the electronic device 100 to process the first preview image through an artificial intelligence engine 215 to identify first facial characteristics of the photograph subjects 210a-210c and comparing the facial characteristic with the images on which the second AI model 126b was trained. In the illustrative embodiments, the rendered indicator 320 shows that the first and third photograph subjects 210a-210c are not looking at the camera 152 (i.e., not looking towards the electronic device 100).

FIG. 3B depicts the result following the process described in relation to FIG. 3A whereby photograph subjects 210a-210c are subsequently found to be engaged in the photo capture process and ready for photo capture. The process includes the controller 110 configuring the electronic device 100 to continuously monitor eyes of all photograph subjects 210a-210c. Then, the controller 110 configures the electronic device 100 to capture a second preview image 311. In response to determining that all photograph subjects 210a-210c are looking towards the camera 152 (electronic device 100), the controller 110 configures the electronic device 100 to render an indicator showing that all photograph subjects 210a-210c are engaged in the photograph process. A persistent image of the engaged photograph subjects 210a-210c is subsequently captured by the first camera 152.

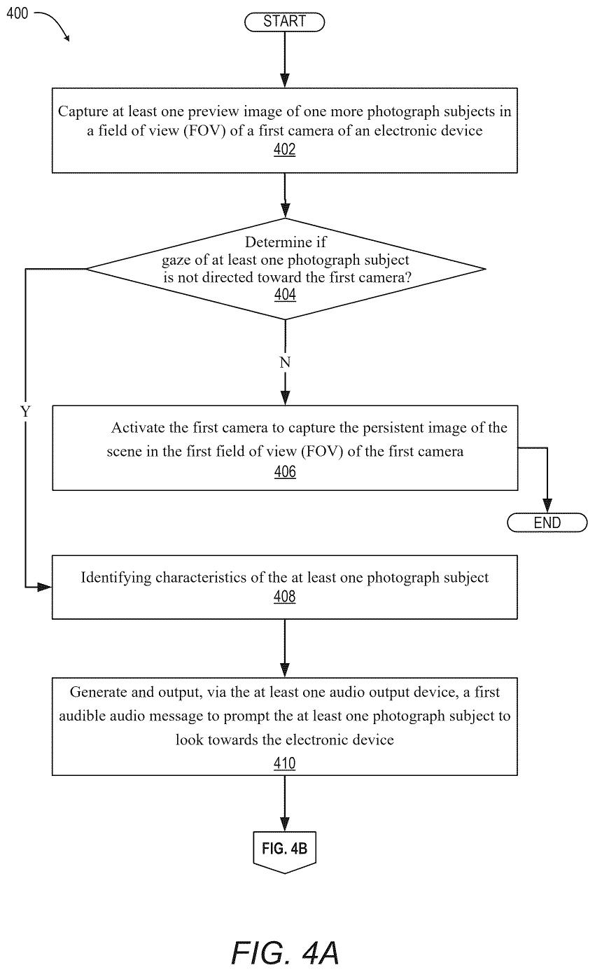

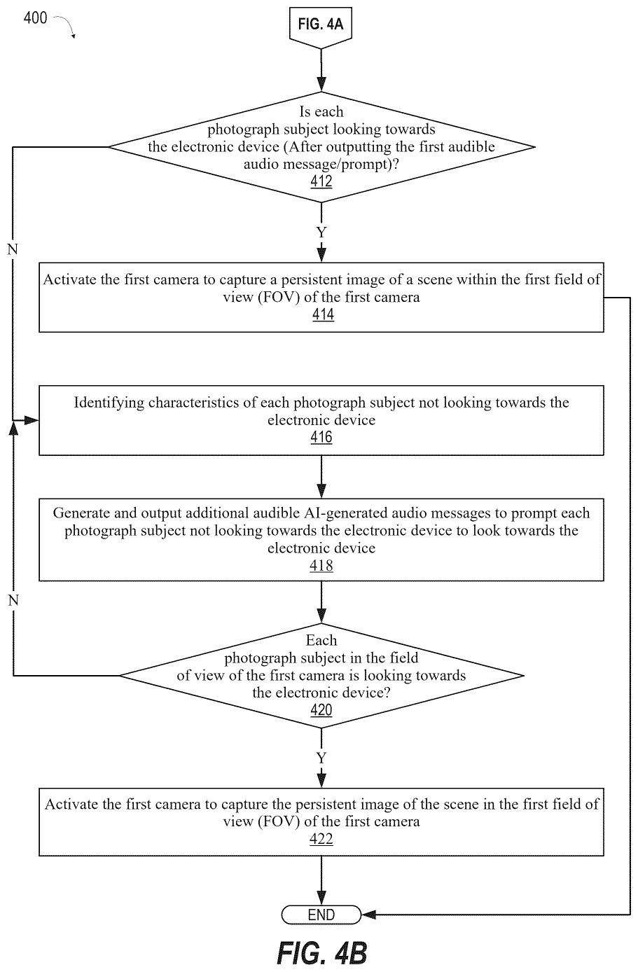

Referring now to the flowchart presented by FIG. 4A-FIG. 4B (collectively FIG. 4), the description of the method in FIG. 4 is provided with general reference to the specific components and features illustrated within preceding FIGS. 1A-1C, 2A-2B, and 3A-3B. Specific components referenced in the method of FIG. 4 may be identical or similar to components of the same name used in describing preceding FIGS. 1A-1C, 2A-2B, and 3A-3B. In one or more embodiments, controller 110 (FIG. 1) is configured to cause the electronic device 100 (FIG. 1) to provide the described functionality of the method of FIG. 4 by executing program code for one or more modules or applications provided within device data storage 140 of first electronic device 100, including GCP module 125 (FIG. 1).

FIGS. 4A-4B depict a flow diagram presenting method 400 of evaluating attentiveness of photographic subjects and outputting visual and audio prompting for distracted photograph subjects, according to one or more embodiments. The method 400 begins with FIG. 4A at block 402, where controller 110 causes the electronic device 100 to capture at least one preview image of one more photograph subject(s) in a field of view (FOV) 330 of a first camera 152 of an electronic device 100. The method continues to block 404, where controller 110 causes the electronic device 100 to determine whether the gaze of at least one photograph subject 210a-210c is not directed toward the electronic device 100. This determination is made by analyzing (e.g., performing gaze analysis of) at least one preview image 310 to determine whether a gaze of at least one photograph subject 210a-210c among the one or more photograph subjects 210a-210c is not directed toward the electronic device 100. If the determination is negative (i.e., in response to detecting that each photograph subject 210a-210c is looking towards the electronic device 100), the method continues to block 406, where controller 110 causes the electronic device 100 to activate the first camera 152 to capture the persistent image of the scene in the first field of view (FOV) 330 of the first camera 152. The image with the photographic subjects is therefore captured in response to detecting that each photograph subject 210a-210c is looking towards the electronic device 100. Then the method ends. If the determination is positive, the method continues to block 408, where controller 110 causes the electronic device 100 to identify characteristics of the at least one photograph subject 210a-210c not looking towards the electronic device 100. The method continues to block 410, where controller 110 causes the electronic device 100 to generate and output, via the at least one audio output device 163, a first audible audio message 220 to prompt the at least one photograph subject to look towards the electronic device 100. Then the method proceeds to FIG. 4B.

At FIG. 4B, the method 400 continues to block 412, where controller 110 causes the electronic device 100 to determine, after outputting the first audible audio message 220 to prompt the at least one photograph subject 210a-210c to look towards the electronic device 100, whether each photograph subject 210a-210c in the field of view 330 of the first camera 152 is looking towards the electronic device 100. If the determination is positive (i.e., in response to detecting that each photograph subject 210a-210c is looking towards the electronic device 100), the method 400 continues to block 414, where controller 110 causes the electronic device 100 to activate the first camera 152 to capture a persistent image of a scene within the first field of view (FOV) 330 of the first camera 152. Then the method ends. If the determination is negative, the method continues to block 416, where controller 110 causes the electronic device 100 to identify characteristics of each photograph subject 210a-210c not looking towards the electronic device 100. The method continues to block 418, where controller 110 causes the electronic device 100 to generate and output additional audible AI-generated audio messages 220 to prompt each photograph subject 210a-210c not looking towards the electronic device 100 to look towards the electronic device 100. The AI-generated audio messages 220 can be subject-specific unique messages that incorporate one or more identifying characteristics of the subject who is not looking towards the electronic device. The method continues to block 420, where a determination is made as to whether each 210a-210c photograph subject in the field of view 330 of the first camera 152 is looking towards the electronic device 100. If that determination is negative, the method returns to block 416. If the determination is positive (i.e., in response to detecting that each photograph subject 210a-210c is looking towards the electronic device 100), the method proceeds to block 422, where controller 110 causes the electronic device 100 to activate the first camera 152 to capture the persistent image of the scene in the first field of view (FOV) 330 of the first camera 152.

Accordingly, by implementing the above-described processes, a user of an electronic device may prompt distracted photograph subjects to re-engage with the photography process. The described methods represent an improvement over existing methods of prompting distracted photograph subjects which require manual prompting by the photographer or reliance on far less-than foolproof automatic means of prompting. The prescribed methods allow a user to present a continuous real-time visual of the potential captured image to photograph subjects continually and to bolster this visual prompt with auditory tailored for photograph subjects based on their appearance. The improvements contemplated herein make photographing people with handheld electronic devices a more predictable, less frustrating process.

In the above-described methods, one or more of the method processes may be embodied in a computer readable device containing computer readable code such that operations are performed when the computer readable code is executed on a computing device. In some implementations, certain operations of the methods may be combined, performed simultaneously, performed in a different order, or omitted, without deviating from the scope of the disclosure. Further, additional operations may be performed, including operations described in other methods. Thus, while the method operations are described and illustrated in a particular sequence, use of a specific sequence of operations is not meant to imply any limitations on the disclosure. Changes may be made with regard to the sequence of operations without departing from the spirit or scope of the present innovation. Use of a particular sequence is therefore not to be taken in a limiting sense, and the scope of the present disclosure is defined primarily by the appended claims.

Aspects of the present innovation are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present innovation may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description but is not intended to be exhaustive or limited to the disclosure in the form disclosed. Many modifications and variations will be apparent to those of ordinary skill in the art without departing from the scope of the innovation. The described embodiments were chosen and described in order to best explain the principles of the disclosure and their practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the innovation has been described with reference to example embodiments, it will be understood by those skilled in the art that various changes may be made, and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
at least one audio output device;
at least one image capturing device comprising a first camera embedded in an outward facing surface of a housing of the electronic device;
a memory having stored thereon a photograph gaze correction prompt (GCP) module for prompting photograph subjects who are not looking towards the electronic device to look towards the electronic device; and
at least one processor communicatively coupled to the at least one audio output device, the at least one camera, and the memory, the at least one processor executing program code of the photograph gaze correction prompt module, and configured to cause the electronic device to:
while the electronic device is in an image capture mode, using the first camera capture at least one preview image captured in a first field of view (FOV) of the first camera of one or more photograph subjects;
analyze the at least one preview image to determine whether a gaze of at least one photograph subject among the one or more photograph subjects is not directed toward the electronic device;
in response to detecting that the gaze of at least one photograph subject is not directed toward the electronic device:
identify characteristics of the at least one photograph subject; and
generate and output, via the at least one audio output device, a first audible audio message to prompt the at least one photograph subject to look towards the electronic device.

2. The electronic device of claim 1, wherein the at least one processor is further configured to cause the electronic device to:
determine, after outputting the first audible audio message to prompt the at least one photograph subject to look towards the electronic device, whether each photograph subject in the field of view of the first camera is looking towards the electronic device; and
in response to detecting that each photograph subject of the one or more photograph subjects is looking towards the electronic device, activate the first camera to capture a persistent image of a scene within the first field of view (FOV) of the first camera.

3. The electronic device of claim 1, wherein:
the characteristics of the at least one photograph subject comprise one or more of eye color, hair color, height, build, and style of clothing; and
in order to generate the audible audio message the at least one processor is configured to cause the electronic device to interface with a first AI model, the first AI model being trained beforehand on identified characteristics of several previous photographed subjects captured in several prior persistent images and operative to ingest in real time identified characteristics of the at least one photograph subject and output an audible audio message tailored to the at least one photograph subject.

4. The electronic device of claim 2, wherein, prior to activating the first camera to capture the persistent image, the at least one processor is further configured to cause the electronic device to:
continuously monitor eyes of all photograph subjects among the one or more photograph subjects;
capture a second preview image;
in response to at least one of the one or more photograph subjects not looking towards the electronic device:
identify characteristics of each photograph subject not looking towards the electronic device;
generate and output additional audible AI-generated audio messages to prompt each photograph subject not looking towards the electronic device to look towards the electronic device;
determine whether each photograph subject in the field of view of the first camera is looking towards the electronic device;
in response to detecting that each photograph subject among the one or more photograph subjects is looking towards the electronic device, activate the first camera to capture the persistent image of the scene in the first field of view (FOV) of the first camera.

5. The electronic device of claim 4, wherein the processor is operative to cause the electronic device to:
in response to determining that one or more photograph subjects are still not looking at the electronic device, repeat a presentation of audible audio messages a preset number of times; and
in response to determining that one or more photograph subjects are still not looking at the electronic device after presenting a preset number of repeated audible prompts, trigger activation of the capturing of the image.

6. The electronic device of claim 2, wherein the processor is configured to cause the electronic device to:
map a face of each photograph among the one or more photograph subjects;
interface with a second AI model trained beforehand on images of persons looking towards a camera and images of persons looking away from a camera; and
to determine whether the at least one photograph is not looking toward the electronic device:
process the first preview image through an artificial intelligence engine to identify a first facial characteristic of the at least one photograph subject and compare the first facial characteristic with the images on which the AI model was trained.

7. The electronic device of claim 1, wherein the electronic device further comprises:
a foldable enclosure comprising a first housing and a second housing coupled by a hinge such that the first housing is pivotable about the hinge relative to the second housing between a closed position and an axially displaced open position;
a first display embedded in an outward facing surface of a housing of the electronic device and communicatively coupled to the at least one processor;
a second display embedded in an inward facing surface of the housing of the electronic device opposed to the outward facing surface of the housing in which the first display and first camera are embedded, wherein the second display is communicatively coupled to the at least one processor; and
wherein the at least one processor is configured to cause the electronic device to:
present a first graphical user interface (GUI) on the second display, the first GUI including the first preview image captured via the first camera and an indicator identifying whether or not all photograph subjects in the FOV of the first camera are looking at the electronic device.

8. The electronic device of claim 7, wherein the processor is configured to cause the electronic device to:
present the first preview image on the first display concurrent with the presentation of the first preview image on the second display.

9. A method comprising:
capturing at least one preview image of one more photograph subjects in a field of view (FOV) of a first camera of an electronic device;
analyzing the at least one preview image to determine whether a gaze of at least one photograph subject among the one or more photograph subjects is not directed toward the first electronic device; and
in response to detecting that the gaze of at least one photograph subject is not directed toward the electronic device:
identifying characteristics of the at least one photograph subject; and
generating and output, via at least one audio output device, a first audible audio message to prompt the at least one photograph subject to look towards the electronic device.

10. The method of claim 9, the method further comprising:
determining, after outputting the first audible audio message to prompt the at least one photograph subject to look towards the electronic device, whether each photograph subject in the field of view of the first camera is looking towards the electronic device; and
in response to detecting that each photograph subject of the one or more photograph subjects is looking towards the electronic device, activating the first camera to capture a persistent image of a scene within the first field of view (FOV) of the first camera.

11. The method of claim 9, wherein the characteristics of the at least one photograph subject comprise one or more of eye color, hair color, height, build, and style of clothing; and
in order to generate the audible audio message at least one processor is configured to cause the electronic device to: interface with a first AI model, the first AI model being trained beforehand on identified characteristics of several previous photograph subjects captured in several prior persistent images and operative to ingest in real time identified characteristics of the at least one photograph subject and output an audible audio message tailored to the at least one photograph subject.

12. The method of claim 10, wherein, prior to activating the first camera to capture the persistent image, the method further comprises:
continuously monitoring eyes of all photograph subjects among the one or more photograph subjects;
capturing a second preview image; and
in response to at least one of the one or more photograph subjects not looking towards the electronic device:
identifying characteristics of each photograph subject not looking towards the electronic device;
generating and outputting additional audible AI-generated audio messages to prompt each photograph subject not looking towards the electronic device to look towards the electronic device;
determining whether each photograph subject in the field of view of the first camera is looking towards the electronic device; and
in response to detecting that each photograph subject among the one or more photograph subjects is looking towards the electronic device, activating the first camera to capture the persistent image of the scene in the first field of view (FOV) of the first camera.

13. The method of claim 12, the method further comprising:
in response to determining that one or more photograph subjects are still not looking at the electronic device: repeating a presentation of audible audio messages a preset number of times; and
in response to determining that one or more photograph subjects are still not looking at the electronic device after presenting a preset number of repeated audible prompts: triggering activation of the capturing of the image.

14. The method of claim 10, the method further comprising:
mapping a face of each photograph subject among the one or more photograph subjects;
interfacing with a second AI model trained beforehand on images of persons looking towards a camera and images of persons looking away from a camera; and
to determine whether the at least one photograph subject is not looking toward the electronic device:
processing the first preview image through an artificial intelligence engine to identify a first facial characteristic of the at least one photograph subject and comparing the first facial characteristic with the images on which the AI model was trained.

15. The method of claim 9, the method further comprises:
presenting a first graphical user interface (GUI) on a second display embedded in an inward facing surface of a housing of the electronic device opposed to an outward facing surface of the housing, the first GUI including the first preview image captured via the first camera and an indicator identifying whether or not all photograph subjects in the FOV of the first camera are looking at the electronic device.

16. The method of claim 15, the method further comprising:
presenting the first preview image on a first display embedded in an outward facing surface of a housing of the electronic device, concurrent with the presentation of the first preview image on the second display.

17. A computer program product comprising a non-transitory computer readable medium having program instructions that when executed by a processor of an electronic device, configure the electronic device to perform functions comprising:
capturing at least one preview image of one more photograph subjects in a field of view (FOV) of a first camera of an electronic device;
analyzing the at least one preview image to determine whether a gaze of at least one photograph subject among the one or more photograph subjects is not directed toward the electronic device; and
in response to detecting that the gaze of at least one photograph subject is not directed toward the electronic device:
identifying characteristics of the at least one photograph subject; and
generating and output, via at least one audio output device, a first audible audio message to prompt the at least one photograph subject to look towards the electronic device.

18. The computer program product of claim 17, further comprising program instructions for:
determining, after outputting the first audible audio message to prompt the at least one photograph subject to look towards the electronic device, whether each photograph subject in the field of view of the first camera is looking towards the electronic device; and
in response to detecting that each photograph subject of the one or more photograph subjects is looking towards the electronic device, activating the first camera to capture a persistent image of a scene within the first field of view (FOV) of the first camera.

19. The computer program product of claim 18, further comprising program instructions for, prior to activating the first camera to capture the persistent image:
continuously monitoring eyes of all photograph subjects among the one or more photograph subjects;
capturing a second preview image; and
in response to at least one of the one or more photograph subjects not looking towards the electronic device:
identifying characteristics of each photograph subject not looking towards the electronic device;
generating and outputting additional audible AI-generated audio messages to prompt each photograph subject not looking towards the electronic device to look towards the electronic device;
determining whether each photograph subject in the field of view of the first camera is looking towards the electronic device; and
in response to detecting that each photograph subject among the one or more photograph subjects is looking towards the electronic device, activating the first camera to capture the persistent image of the scene in the first field of view (FOV) of the first camera.

20. The computer program product of claim 19, further comprising program instructions for: in
response to determining that one or more photograph subjects are still not looking at an electronic device: repeating a presentation of audible audio messages a preset number of times; and
in response to determining that one or more photograph subjects are still not looking at the electronic device after presenting a preset number of repeated audible prompts: triggering activation of the capturing of the image.
